(19) United States
(12) Patent Application Publication
(10) Pub. No.: US 2003/0086331 A1
(43) Pub. Date: May 8, 2003

(54) Extrusion molding machine

(76) Inventor: Jun-Rong Lin, Taichung (TW)

Correspondence Address: Jun-Rong Lin, 58, MA YUAN WEST ST., TAICHUNG, TW

(21) Appl. No.: 10/010,059

(22) Filed: Nov. 8, 2001

(51) Int. Cl. B29B 7/48

(52) U.S. Cl. 366/97; 366/272

(57) ABSTRACT

An extrusion molding machine has a main extrusion molding device, and a drive mechanism connected to the main extrusion molding device. The drive mechanism has a motor device, a transmission case, and a drive shaft connected to the motor device. The drive shaft passes through the transmission case. The main extrusion molding device has an upper feed inlet, a lower chamber, and a gear mechanism therein. The gear mechanism has a first pinion, a second pinion engaging with the first pinion, a third pinion engaging with the second pinion, a main gear engaging with the first pinion, a fourth pinion engaging with the main gear, a fifth pinion engaging with the fourth pinion, a sixth pinion engaging with the fifth pinion, and a seventh pinion engaging with the sixth pinion. The main gear encloses the drive shaft.

### BACKGROUND OF THE INVENTION

The present invention relates to an extrusion molding machine. More particularly, the present invention relates to an extrusion molding machine which has a main extrusion molding device having a plurality of gears.

Referring to FIG. 9, a conventional extrusion molding machine 5 has a main cylinder 51, a feed hopper 57 connected to the main cylinder 51, a screw rod 52 disposed in the main cylinder 51, a blending rod 522 disposed in the main cylinder 51, the blending rod 522 connected to the screw rod 52, a plurality of spiral teeth 521 surrounding the screw rod 52, and the main cylinder 51 having a feeding portion 53, a compression portion 54, a blending portion 55, a metering portion 56, and an outlet 58. A raw material is poured into the feed hopper 57. The raw material enters the feeding portion 53 of the main cylinder 51. The screw rod 52 will rotate to move the raw material to the compression portion 54, the blending portion 55, the metering portion 56, and the outlet 58 of the main cylinder 51. Since the screw rod 52 is located transversely, the gravity principle cannot be used. Therefore, a motor should have a large power in order to drive the screw rod 52. Furthermore, the screw rod 52 is easily broken.

### SUMMARY OF THE INVENTION

An object of the present invention is to provide an extrusion molding machine which has a main extrusion molding device having a plurality of gears in order to mix and blend a raw material evenly.

Another object of the present invention is to provide an extrusion molding machine which has a main extrusion molding device having a plurality of gears arranged longitudinally according to the principle of gravity.

Accordingly, an extrusion molding machine comprises a main extrusion molding device, and a drive mechanism connected to the main extrusion molding device. The main extrusion molding device has an upper feed inlet, a lower chamber, and a gear mechanism therein. The gear mechanism has a main gear and a plurality of pinions. A feed mechanism has the main gear, a first portion of the gear mechanism, and a containing interior. The feed mechanism is adjacent to the upper feed inlet of the main extrusion molding device. A compression mechanism is disposed below the feed mechanism. The compression mechanism has the main gear, a second portion of the gear mechanism, and a guide interior. A blending mechanism is disposed below the compression mechanism. The blending mechanism has a third portion of the gear mechanism, and a blending spacing. A metering mechanism is disposed below the blending mechanism. The metering mechanism has a fourth portion of the gear mechanism. The lower chamber of the main extrusion molding device communicates with the metering mechanism.

### BRIEF DESCRIPTION OF THE DRAWINGS

FIG. 1 is an elevational view of an extrusion molding machine of a first preferred embodiment in accordance with the present invention;

FIG. 2 is a sectional view of a main extrusion molding device of a first preferred embodiment taken along line 2A-2A in FIG. 1;

FIG. 3 is a partially sectional view of a feed mechanism of a first preferred embodiment in accordance with the present invention;

FIG. 4 is a partially sectional view of a compression mechanism of a first preferred embodiment in accordance with the present invention;

FIG. 5 is a partially sectional view of a blending mechanism of a first preferred embodiment in accordance with the present invention;

FIG. 6 is a partially sectional view of a metering mechanism of a first preferred embodiment in accordance with the present invention;

FIG. 7 is a sectional view of a main extrusion molding device of a second preferred embodiment in accordance with the present invention;

FIG. 8 is another sectional view of a main extrusion molding device of a second preferred embodiment in accordance with the present invention; and

FIG. 9 is a sectional view of an extrusion molding machine of the prior art.

### DETAILED DESCRIPTION OF THE INVENTION

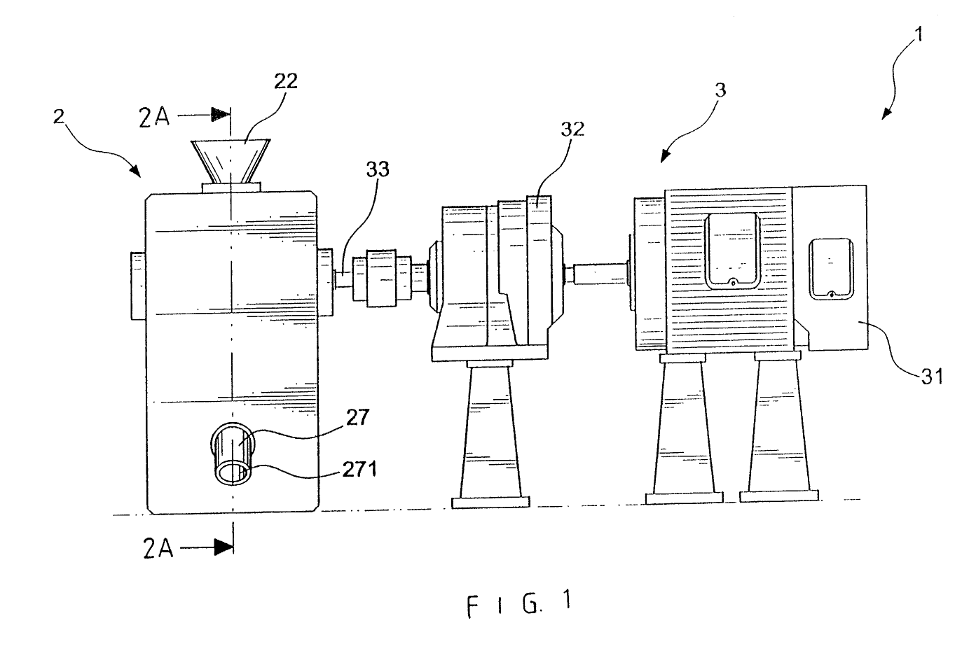

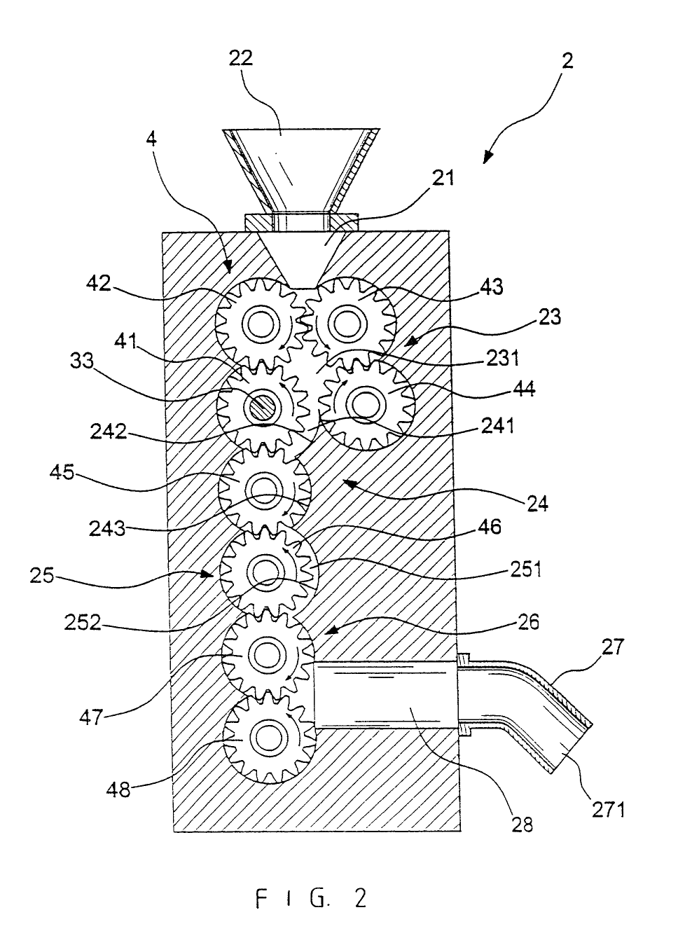

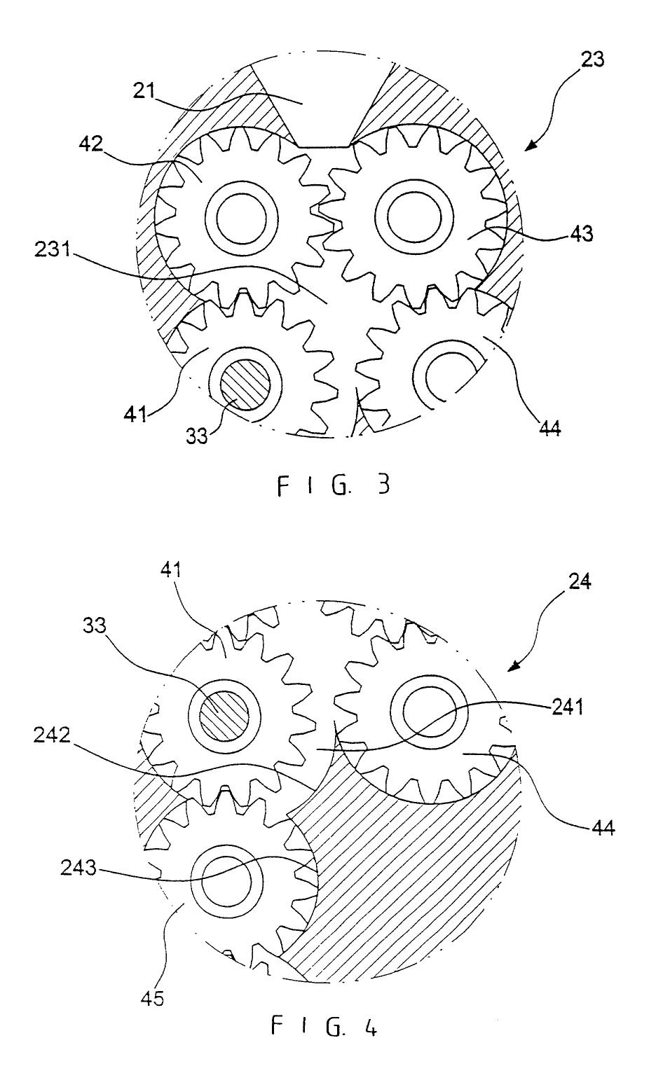

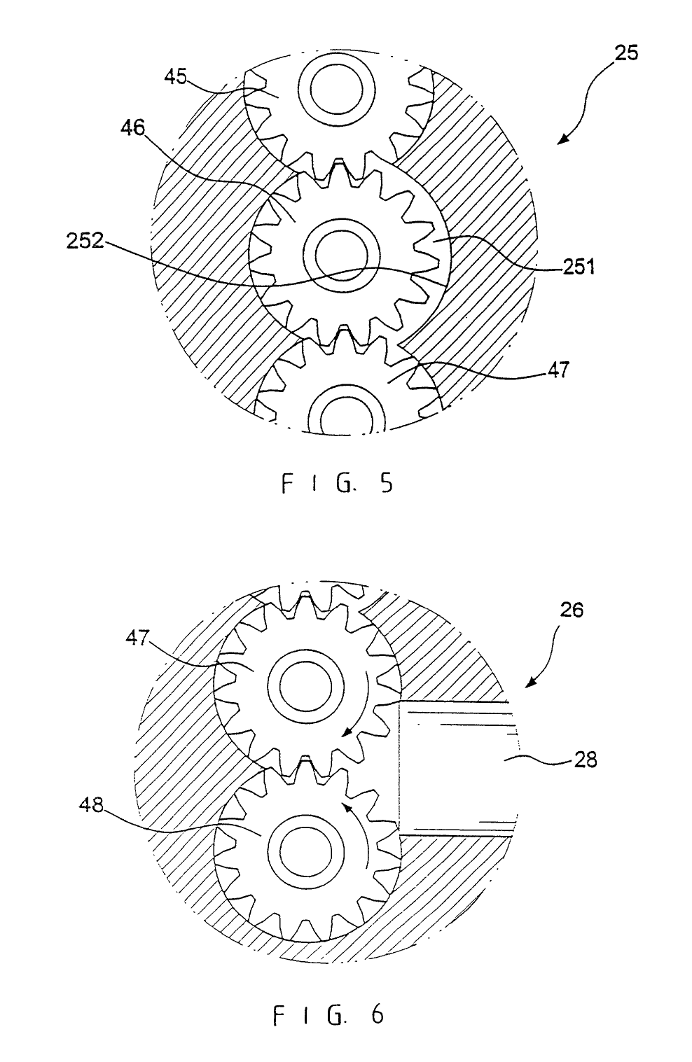

Referring to FIGS. 1 to 6 first, an extrusion molding machine 1 comprises a main extrusion molding device 2, and a drive mechanism 3 connected to the main extrusion molding device 2.

The drive mechanism 3 has a motor device 31, a transmission case 32, and a drive shaft 33 connected to the motor device 31.

The drive shaft 33 passes through the transmission case 32 to be inserted in the main extrusion molding device 2.

The main extrusion molding device 2 has an upper feed inlet 21, a lower chamber 28, and a gear mechanism 4 therein.

A feed hopper 22 is disposed on the main extrusion molding device 2 to communicate with the upper feed inlet 21 of the main extrusion molding device 2.

A discharge pipe 27 is disposed on the main extrusion molding device 2 to communicate with the lower chamber 28 of the main extrusion molding device 2.

The discharge pipe 27 has an outlet 271.

The gear mechanism 4 has a first pinion 42, a second pinion 43 engaging with the first pinion 42, a third pinion 44 engaging with the second pinion 43, a main gear 41 engaging with the first pinion 42, a fourth pinion 45 engaging with the main gear 41, a fifth pinion 46 engaging with the fourth pinion 45, a sixth pinion 47 engaging with the fifth pinion 46, and a seventh pinion 48 engaging with the sixth pinion 47.

The main gear 41 encloses the drive shaft 33.

A feed mechanism 23 has the first pinion 42, the second pinion 43, the third pinion 44, the main gear 41, and a containing interior 231 defined by the first pinion 42, the second pinion 43, the third pinion 44, and the main gear 41.

The feed mechanism 23 is adjacent to the upper feed inlet 21 of the main extrusion molding device 2.

A compression mechanism 24 has the third pinion 44, the main gear 41, the fourth pinion 45, and a guide interior 241 formed between the main gear 41 and a guide surface 242 of the main extrusion molding device 2.

The fourth pinion 45 contacts a compression surface 243 of the main extrusion molding device 2 tightly.

The guide interior 241 of the compression mechanism 24 is located below the containing interior 231 of the feed mechanism 23.

A blending mechanism 25 has the fifth pinion 46 and a blending spacing 251 formed between the fifth pinion 46 and a blending surface 252 of the main extrusion molding device 2.

A metering mechanism 26 has the sixth pinion 47 and the seventh pinion 48.

The lower chamber 28 of the main extrusion molding device 2 communicates with the metering mechanism 26.

A raw material such as a plastics material and a rubber material is poured into the feed hopper 57. The raw material enters the upper feed inlet 21 of the main extrusion molding device 2. Then the raw material enters the containing interior 231 of the feed mechanism 23, the guide interior 241 of the compression mechanism 24, the blending spacing 251 of the blending mechanism 25, the metering mechanism 26, the lower chamber 28 of the main extrusion molding device 2, and the discharge pipe 27.

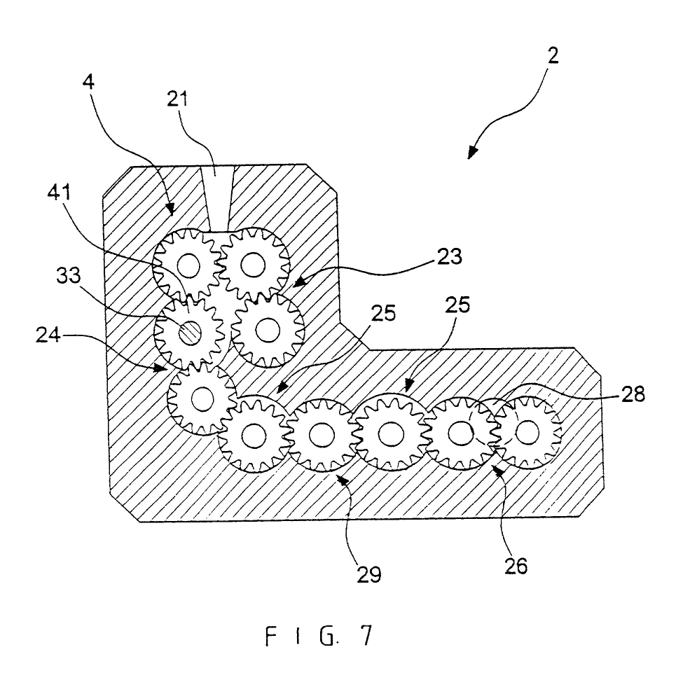

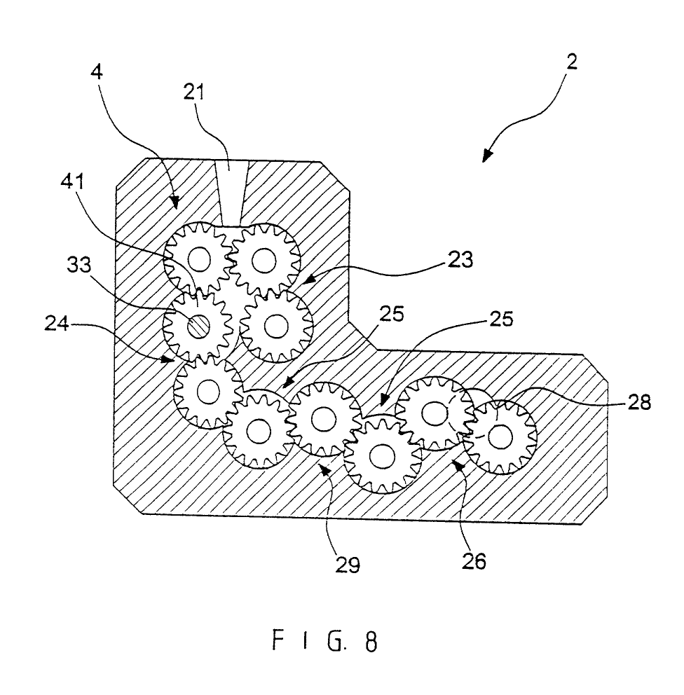

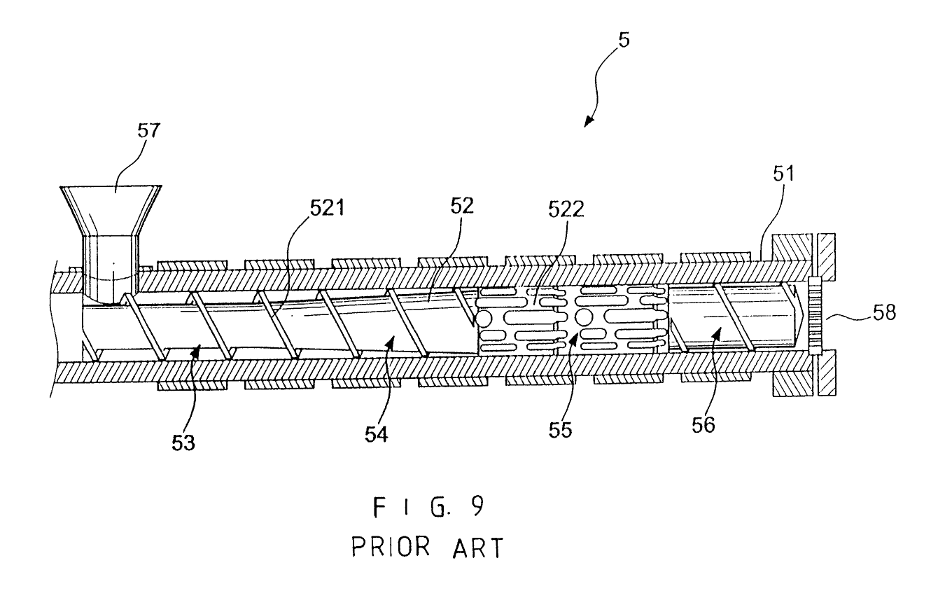

Referring to FIGS. 7 and 8, another extrusion molding machine 1 comprises a main extrusion molding device 2. The main extrusion molding device 2 has an additional feeding mechanism 29 inserted in the blending mechanism 25.

The blending mechanism 25 and the metering mechanism 26 are arranged transversely.

The invention is not limited to the above embodiment but various modification thereof may be made. Further, various changes in form and detail may be made without departing from the scope of the invention.

I claim:

1. An extrusion molding machine comprises:
a main extrusion molding device, and a drive mechanism connected to the main extrusion molding device,
the main extrusion molding device having an upper feed inlet, a lower chamber, and a gear mechanism therein,
the gear mechanism having a main gear and a plurality of pinions,
a feed mechanism having the main gear, a first portion of the gear mechanism, and a containing interior,
the feed mechanism adjacent to the upper feed inlet of the main extrusion molding device,
a compression mechanism disposed below the feed mechanism,
the compression mechanism having the main gear, a second portion of the gear mechanism, and a guide interior,
a blending mechanism disposed below the compression mechanism,
the blending mechanism having a third portion of the gear mechanism, and a blending spacing,
a metering mechanism disposed below the blending mechanism,
the metering mechanism having a fourth portion of the gear mechanism, and
the lower chamber of the main extrusion molding device communicating with the metering mechanism.

2. The extrusion molding machine as claimed in claim 1, wherein the drive mechanism has a motor device, a transmission case, and a drive shaft connected to the motor device, and the drive shaft passes through the transmission case to be inserted in the main extrusion molding device.

3. The extrusion molding machine as claimed in claim 1, wherein a feed hopper is disposed on the main extrusion molding device to communicate with the upper feed inlet of the main extrusion molding device.

4. The extrusion molding machine as claimed in claim 1, wherein a discharge pipe is disposed on the main extrusion molding device to communicate with the lower chamber of the main extrusion molding device, and the discharge pipe has an outlet.

5. The extrusion molding machine as claimed in claim 1, wherein the blending mechanism and the metering mechanism are arranged transversely.

6. The extrusion molding machine as claimed in claim 1, wherein a feeding mechanism is inserted in the blending mechanism.
